(19) United States
(12) Patent Application Publication
(10) Pub. No.: US 2012/0192756 A1
(43) Pub. Date: Aug. 2, 2012

(54) RAIL VISION SYSTEM

(75) Inventors: Robert S. MILLER, Columbia, SC (US); Anthony P. DELUCIA, Gaston, SC (US)

(73) Assignee: HARSCO CORPORATION, Camp Hill, PA (US)

(21) Appl. No.: 13/017,133

(22) Filed: Jan. 31, 2011

(51) Int. Cl. E01B 29/00; G06K 9/00; G06F 19/00

(52) U.S. Cl. 104/2; 701/19; 382/104

(57) ABSTRACT

A vision inspection system and method for use with a railcar includes a vision device adapted to provide an image of each rail component. An image recognition component analyzes the images taken by the vision device to determine the type and condition of each rail component as the vehicle is traveling on the railroad track. A control system communicates with the vision device and the image recognition component. The control system causes workheads of the vehicle to engage respective rail components based on the input received from the vision inspection system. A method for determining the relative distance between the rail components includes comparing the position of the respective rail components of a first image to the position of the respective rail components of a second image to determine the distance between the respective components and distance the railcar has moved.

### FIELD OF THE INVENTION

The present invention is directed to a system and method for locating rail components of a railroad track, and communicating such information to a satellite device.

### BACKGROUND OF THE INVENTION

Maintaining proper condition of rail components of a railroad track is of paramount importance in the railroad transportation industry. Rail components include anchors, tie plates, spikes, ties, joint bars, etc. The condition of the railroad components greatly impacts safety and reliability of the track and the rail transportation. Failure or degradation of various rail components of a railroad track can cause derailment of a train traveling on the track. Such derailment can cause significant property damage and injury to passengers, crew and bystanders.

Visual inspection by an operator is one way to monitor the condition of railroad track and components and to ensure that the track is in good condition. However, the quality of visual inspection is generally poor, especially when the visual inspection is performed from a hi-rail vehicle, which is a vehicle that has been modified to drive on railroad tracks. Such hi-rail vehicles are often used by an inspector to travel on the railroad track while simultaneously inspecting the railroad track.

The limitation of this prior art method of inspecting railroad components is that it is time-consuming and labor intensive, particularly as the operator must then position various machines of the rail consist over the problem areas. Inspection that is performed on foot can provide better results, since the inspector can more closely and carefully inspect each of the rail components. However, inspection performed on foot is a slow and tedious process, requiring many hours to inspect several miles of railroad track.

U.S. Pat. No. 6,356,299 to Trosino et al. discloses an automated track inspection vehicle for inspecting a railroad track for various anomalies. The automated track inspection vehicle disclosed includes a self-propelled car equipped with cameras for creating images of the track. This reference discloses that a driver and an inspector visually inspect the track and right-of-way through a window in the vehicle, thereby identifying anomalies such as presence of weeds, blocked drain, improper ballast, missing clip, or defective tie. The reference further discloses that the images from the cameras are viewed by the inspector on a video terminal to detect anomalies on the railroad track. When anomalies are detected by the driver or the inspector, a signal is provided to store the video data for review by an analyst. The reference notes that the analyst reviews the stored video data to confirm the presence of an anomaly, and generates a track inspection report identifying the type and location of the anomaly, as well as the required remedial action.

The significant limitation of the inspection vehicle disclosed in Trosino et al. and the method taught therein requires the inspector to continually perform visual inspection of the railroad track while traveling on the railroad track, such inspection being not much better in quality than the conventional inspection method from a hi-rail vehicle noted above. The method taught also requires three trained individuals at the same time. In addition, the disclosed inspection vehicle requires the inspector to press an appropriate button, indicating the type of anomaly identified, in order for the vehicle to capture and store the images of the railroad track for review by the analyst.

If the inspector does not see the anomaly and/or push the appropriate button, no image that can be reviewed by the analyst is captured. Therefore, whereas the railcar vehicle of Trosino et al. is appropriate for inspecting a railroad track for large anomalies which are easily visible to the inspector, such as the presence of weeds, blocked drain, etc., the described inspection vehicle does not allow facilitated inspection of smaller rail components or smaller defects associated therewith. The reference further discloses that the inspection vehicle allows inspection of a railroad track at speeds of 16-50 miles per hour.

Other known vehicle-based automated systems are directed to rail profile measurement systems which are used to make large numbers of measurements of the rail head for evaluating the condition of the rail head of the running rails. When used for inspection or planning purposes, these rail head profile measurement systems are usually mounted on inspection vehicles, such as railroad track geometry inspection cars that can operate at high speed (80 plus mph or 125 kph) and record images every 5 to 20 feet (1.5 to 6 meters), depending on actual measurement speed.

This type of system allows rail wear information to be obtained on the running rails, together with the detailed rail profiles. Thus, these rail head measurement systems provide information for planning of both rail-grinding and rail replacement (re-laying) activities.

There are currently several such optical- or laser-based systems that are commercially available and in active use. They generally follow the same principle, using a light source or laser to illuminate the rail head. The illuminated rail profile is then recorded by a CCD (charge-coupled device) camera or related recording device, and the image stored in a digitized format. The ORIAN system, distributed by KLD Labs, Inc., represents one such commercially available system that is used on both inspection vehicles and rail grinders. A second commercially available rail measuring system is the Laserail system, distributed by ImageMap, Inc., which is likewise used on both high-speed inspection vehicles and low-speed rail grinders. Other systems, such as the VISTA system, a product of Loram, Inc., are of more limited application, primarily on rail grinders.

While these systems all generate digitized rail head profiles for the running rails, they do not analyze or generate digitized profiles for spikes, tie plates, anchors or other such components. The usefulness of such prior systems has been limited to running rails.

In addition, while these systems generate a digital profile of the rail head, the cameras are not located on the actual equipment which performs the maintenance. Instead, the system records information and locations which are then supplied to the maintenance vehicle when the maintenance is to be performed. This requires additional control systems and location systems to allow the maintenance equipment to be properly positioned.

Therefore, in view of the above, there exists a need for an automated system to be provided on a maintenance vehicle for inspecting and indentifying rail components such as, but not limited to, spikes, tie plates and anchors. It would also be beneficial to provide a system in which the maintenance vehicle can automatically and accurately identify and perform maintenance on components in need of repair. This need exists for both maintenance vehicles which incorporate the use of a satellite device and those which do not have a satellite device.

### SUMMARY OF THE INVENTION

An exemplary embodiment is directed to a railcar or a vehicle adapted to travel on a railroad track and perform maintenance on rail components of the railroad track. The railcar includes a vision inspection system, a control system and workheads. The vision inspection system is adapted to facilitate identification and inspection of the rail components while traveling on the railroad track. The vision inspection system includes a vision device adapted to provide an image of each rail component and an image recognition component which analyzes the images taken by the vision device to determine the type and condition of each rail component. The workheads are configured to perform maintenance on respective rail components. The control system communicates with the vision inspection system and the workheads. The control system causes the workheads to engage respective rail components based on the input received from the vision inspection system.

An exemplary method is disclosed for inspecting and servicing predetermined rail components of a railroad track while traveling on the railroad track. The method includes the steps of: providing a vision inspection system, a control system and at least one workhead on a rail vehicle; using the vision inspection system to take images of a rail of the railroad track; comparing the images of the rail to stored images of rail components to identify the components in the images and to determine if such components are in need of service; and communicating to a control system the location of the rail components in need of service; positioning the at least one workhead in position relative to the rail components in need of service.

An exemplary method is disclosed for identifying rail components of a railroad track and determining the relative distance between the rail components while traveling on the railroad track. The method includes the steps of: taking a first image with a vision inspection system of a rail of a railroad track; analyzing the first image to identify respective rail components of the rail; advancing the vision system to a second position; taking a second image; and comparing the position of the respective rail components of the first image to the position of the respective rail components of the second image to determine the distance the vision system and the rail vehicle have moved.

An exemplary embodiment is directed to a vision inspection system for use with a railcar or a vehicle adapted to travel on a railroad track and perform maintenance on rail components of the railroad track, the vision inspection has a vision device adapted to provide an image of each rail component. An image recognition component analyzes the images taken by the vision device to determine the type and condition of each rail component as the vehicle is traveling on the railroad track. A control system communicates with the vision device and the image recognition component. The control system causes workheads of the vehicle to engage respective rail components based on the input received from the vision inspection system.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a schematic view of a vision inspection system in accordance with one exemplary embodiment.

FIG. 2 is a simplified side view of an exemplary railcar or vehicle which has the vision inspection system provided thereon.

FIG. 3 is a simplified side view of an alternate exemplary railcar or vehicle which has the vision inspection system provided thereon, the railcar having a satellite vehicle associated therewith.

FIG. 4 is a diagrammatic view of a top view of the rail, illustrating a first image being taken by the vision inspection system.

FIG. 5 is a diagrammatic view of the first image illustrating the use of an image recognition component.

FIG. 6 is a diagrammatic view of a top view of the rail similar to FIG. 4, illustrating a second image being taken by the vision inspection system after a first time interval.

FIG. 7 is a diagrammatic view of the second image illustrating the distance traveled in the first time interval.

FIG. 8 is a diagrammatic view of a top view of the rail similar to FIG. 6, illustrating a third image being taken by the vision inspection system after a second time interval.

FIG. 9. is a diagrammatic view of the third image illustrating the distance traveled in the second time interval.

### DETAILED DESCRIPTION OF THE INVENTION

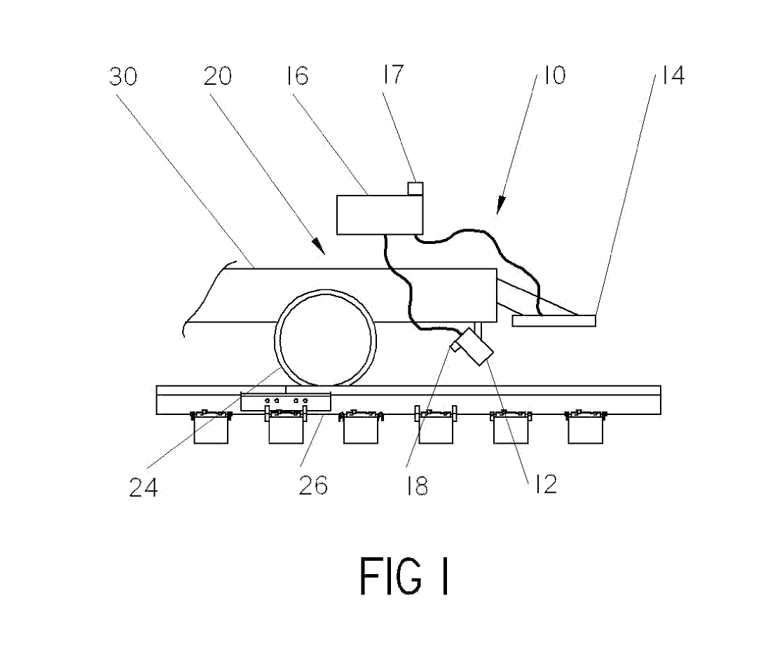

FIG. 1 shows an illustration of a vision system 10 in accordance with one example embodiment of the present invention that facilitates identification, location and/or inspection of rail components while traveling on the railroad track. Components may include, but are not limited to, ties, tie plates, anchors and spikes.

As will be discussed below, the vision system 10 utilizes digital images or pictures, computer imaging, and illumination technologies to allow accurate and efficient location and inspection of rail components, with reduced time and effort as compared to conventional methods. It should be initially noted that whereas the present invention is described in detail below as locating spikes, tie plates and anchors, the present invention is not limited thereto, and may be utilized for location and/or inspection of any rail component that can appropriately be inspected using the vision system 10.

As shown in FIG. 1, the vision system 10 of the illustrated embodiment includes a vision device, such as a high-resolution camera 12 and one or more optional light sources 14. These components are located at the leading end or front of a maintenance vehicle adapted to travel on the rails 26 of the railroad track. It should be noted that FIG. 1 merely shows a schematic illustration of the vision system 10. Thus, the relative positioning of the various components of the vision system 10 is shown merely to facilitate understanding, and need not represent the actual relative positioning of these components. One example of the type of high-resolution camera which can be used are sold by Cognex with appropriate lens configuration, such as the Edmund 16 mm with a Techspec 2/3″ fixed focal length lens. An example of the type of light is the SVL 300 mm OD linear washdown blue light. While a high-resolution camera is described, the vision system 10 may use any type of device which allows visual images to be taken and identified.

The camera 12 is provided with a pattern/image recognition component or member 18, which may be software and/or hardware, which is adapted to process and recognize the images of the rail components that have been captured. The pattern recognition software/hardware may be the Cognex In-Sight 5400 Vision Sensor with PatMax Pattern Recognition Software or any appropriate software/hardware that allows performance of image processing as described in further detail below. If implemented as software, the software can be stored in the memory as well. Alternatively, the vision system 10 may cooperate with a control system 16, which may include a computer and/or other similar components. The control system 16 may have a processor and memory (not shown), for processing and storing data and instructions, and to further capture and store the images of the rail components if desired. In this configuration, the pattern recognition software may be provided in the computer of the control system.

In addition to the vision system 10 and control system 16, a maintenance vehicle or railcar 20 also includes at least one workhead 22 structured to perform maintenance on the railroad track. The workheads 22 may include, but not be limited to, anchor squeezers, spike drivers, track stabilizers, crib booms, tie extractors, single and double brooms, and tampers. A plurality of rail wheels 24 are attached to the frame 30. The wheels 24 are structured to travel over the rails 26. A propulsion device 28 is structured to propel the vehicle 20 over the rails 26. The maintenance vehicle may be a stand-alone piece of equipment or part of a maintenance consist. Consequently, the maintenance vehicle 20 may be self-propelled through the use of a propulsion device 28 positioned on the vehicle 20 or may be propelled by an engine or the like which propels the entire consist.

FIG. 1 shows an example schematic arrangement of various components which are mounted on a frame member 30 of the vehicle or railcar 20 for which the vision system 10 is implemented (only a small portion being shown). In this regard, the camera 12 and light source 14 may be secured to the frame member 30 or other component of the vehicle or railcar in any appropriate manner using brackets, fasteners and/or other securing hardware.

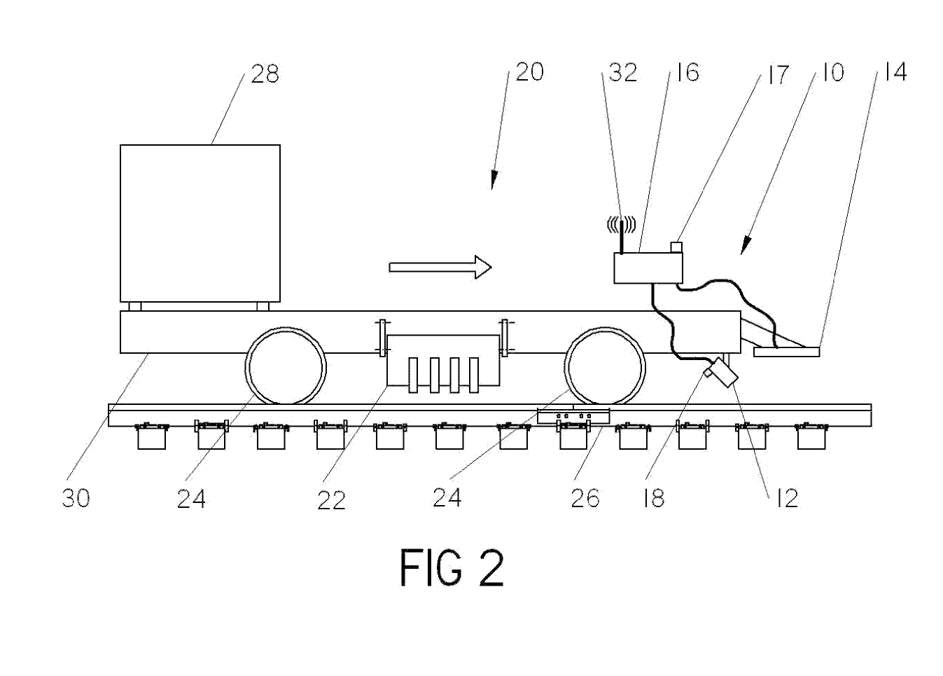

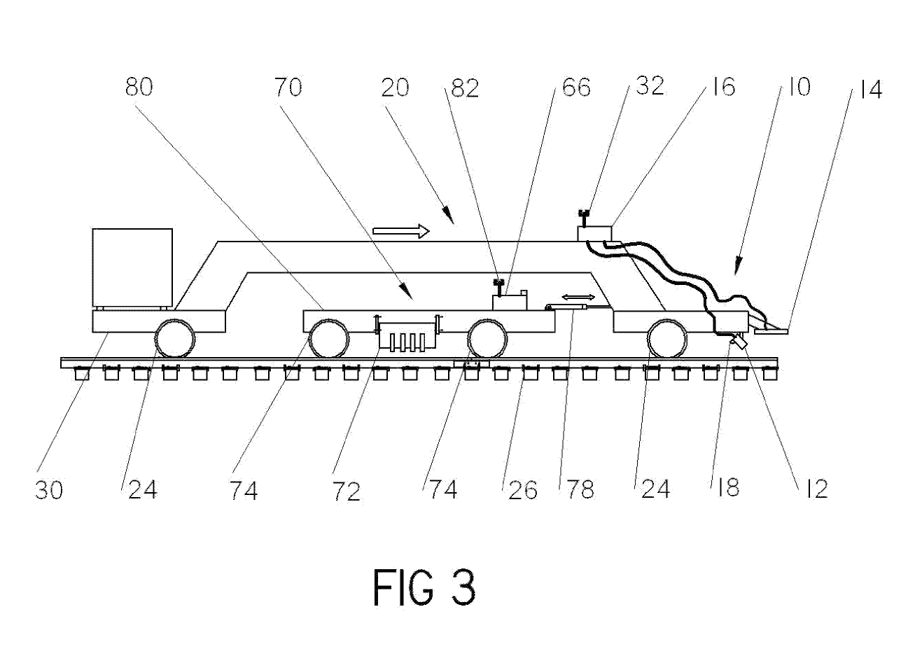

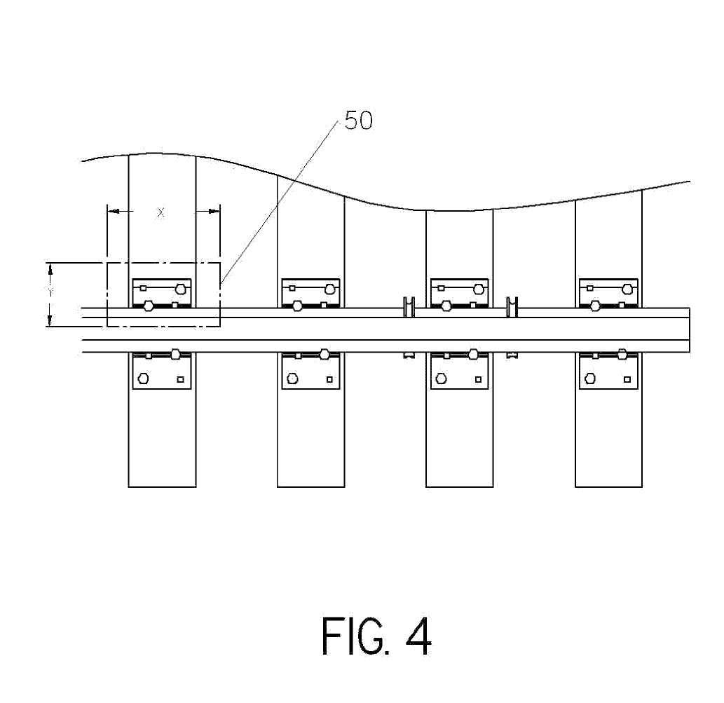

It should be noted that the rails are generally provided with spikes, tie plates, anchors, etc. on both sides of the rails, as shown in FIG. 4. To allow identification, location and inspection of these components, the camera 12 is located above the rail 26 and is approximately centered above the longitudinal axis of the rail, as shown in FIGS. 2 and 3. Alternatively, the camera 12 may be located in other positions, such as slightly offset from the longitudinal axis of the rail. As an illustrative example, two cameras 12 may be located over rail 26. Each camera, including at least one light source 14, is located on either side of the rail 26, so as to better allow for the identification, location and inspection of the components on either side of the rail 26. Moreover, as railroad tracks typically have two parallel rails, additional cameras and optional light sources may be provided to capture images of the parallel rail (not shown). As previously described, these components may be mounted to any appropriate structure in any appropriate manner.

As the railcar 20 is moved, the camera 12 is timed to continually take periodic images of the rail 26. Alternatively, the control system 16 or a timer 17 may be provided to control the intervals or rate at which the images are taken. In the exemplary embodiment described, the camera 12 takes 640×480 pixel resolution images with a size of approximately 16 inches in width. However, images of other resolutions and sizes can be used. Images are taken at the rate of 2-3 images per second. With a railcar or machine forward speed of approximately 15 inches per second, the camera 12 provides sufficient detail and overlap of each frame to orient the images. Other time intervals and speeds may also be calibrated and used. This allows sufficient time for the image to be analyzed inside the camera and indentify any components located therein. As an example, for a tie plate, the pattern recognition software will compare multiple characteristics, such as edges, corners, holes and spikes, to determine if a tie plate is present. The location identified by the images is accurate to approximately 0.025 inches, which is sufficient for all rail maintenance operations to be performed by the railcar 20.

In an alternate exemplary embodiment, random intervals can be used to capture the images, so long as each random interval is limited in duration. Each random interval must be limited to insure that the image captured at the end of the random interval has sufficient overlap with the previous image to allow for the orientation of the image relative to the previous image.

In operation, the position of each component, i.e. tie plate, anchor, etc., is determined relative to the central pixel of the respective image. By comparing sequential images, the change of position of the components is analyzed and computed by the control system 16. Consequently, by analyzing the sequential images, the control system 16 can determine the distance the camera 12 has moved. As the time intervals between the taking of the images is known, and in many cases fixed, the control system can use the distance moved by the camera 12 and the time interval between images to determine the speed of the camera 12. As the camera is fixed to the railcar 20, the speed and location of the camera are consistent with the speed and location of the maintenance vehicle or railcar 20. Consequently, the vision system 10 can be used to accurately position the railcar 20 to which the vision system is attached in position to allow the railcar 20 to perform maintenance on the needed components. In the embodiment described, the features of the track are recognized and identified by the pattern recognition software located in the camera 12, and the resultant positional information of the feature spacing is sent to the control system 16 of the railcar 20. Each vision system 10 provided on the railcar 20 operates in this manner. During the incremental time intervals between images, the railcar 20 speed will not vary significantly and thus the position of all of the maintenance workheads 22, such as, but not limited to, spike pullers, anchor spreaders, anchor squeezers, of the machine that are located on the railcar 20 behind the cameras 12 can be calculated at any point in time and the workheads 22 can be actuated to perform its work function at a predetermined place on the track.

In addition to collecting and tracking distance data, movement data, and component location data, the control system 16 is structured to control the propulsion device 28 and the actuation of the workhead(s) 22. Preferably, this operation is generally automatic. That is, based on the tracking distance data, movement data, and component location data, the control system 16 may engage the propulsion device 28 to move the vehicle 20 into a position so that the workhead(s) 22 is disposed over an appropriate component or tie. The control system 16 may then actuate the vehicle workhead(s) 22 to perform an appropriate cycle on the component.

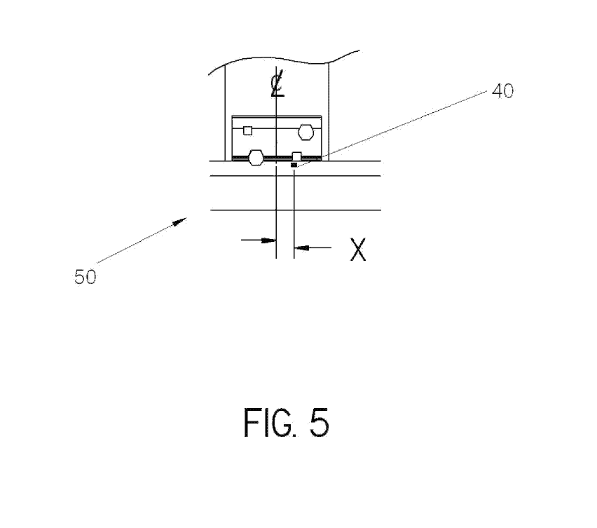

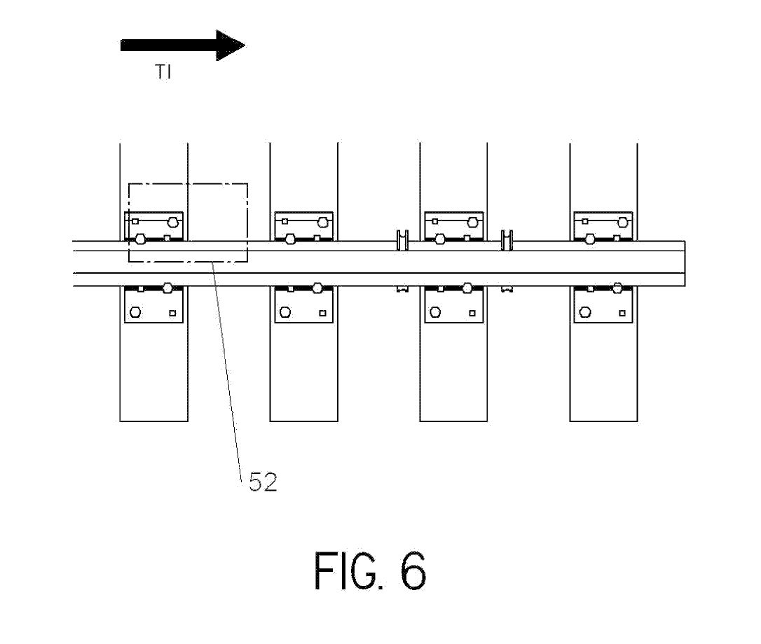

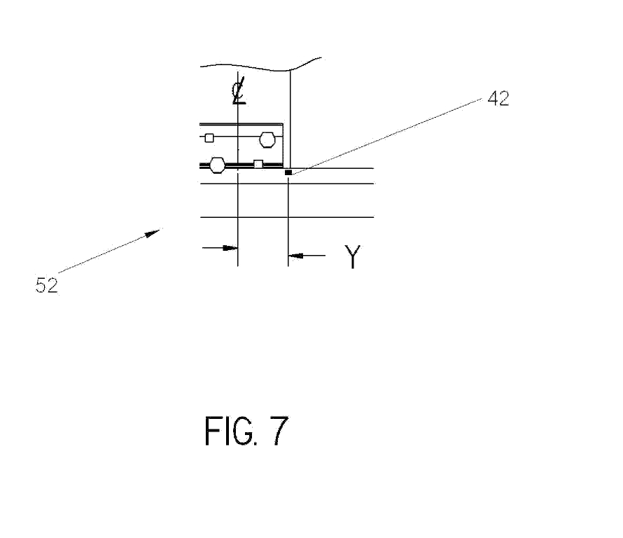

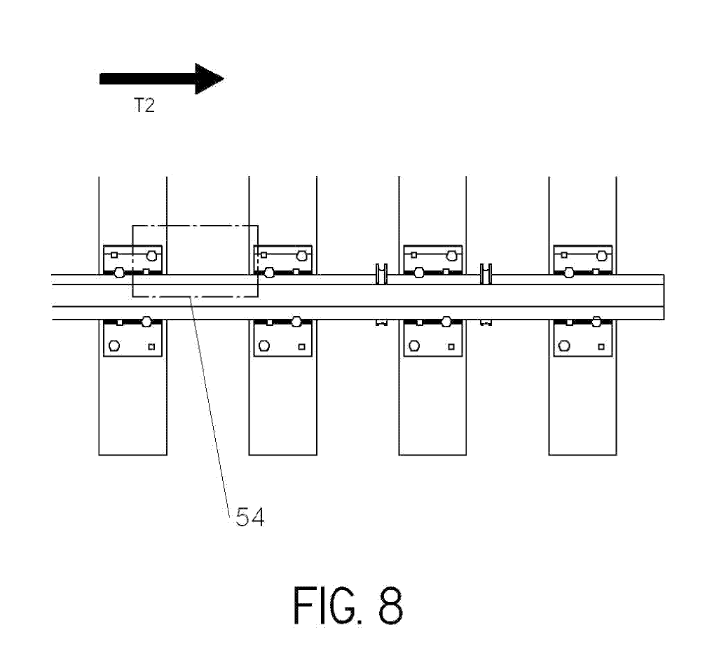

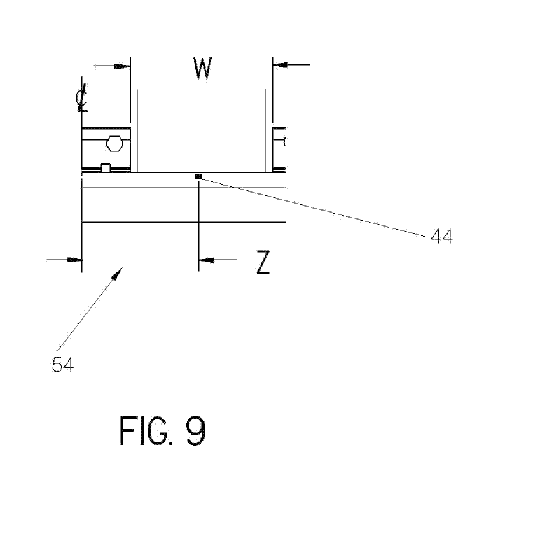

In one exemplary embodiment, the vehicle control system 16, through the use of the vision system 10 described above, will identify a location for a respective component which is need of maintenance. Referring to FIGS. 4 to 9, an example of the process of the vision system is shown. In this example, the component which is identified is a tie plate, but the basic process is similar for any component. The vision system 10 takes a first image, represented by 50, as shown in FIG. 4. As shown in FIG. 5, the image is analyzed by the pattern recognition software to determine that a respective tie plate is positioned in the field of view of the camera 12. Point 40 represents the center pixel of the image 50. The vehicle 20 advances and a second image is taken, represented by 52 in FIG. 6, after a defined time interval T₁. The image is analyzed, as represented in FIG. 7. Point 42 represents the center pixel of the image 52. The difference between X and Y (FIGS. 5 and 7) is the distance the camera 12 and the vehicle 20 traveled during the time interval T₁. The vehicle 20 continues to advance and a third image is taken, represented by 54 in FIG. 8, after a second defined time interval T₂. The image is analyzed, as represented in FIG. 9. Point 44 represents the center pixel of the image 54. The difference between Y and Z (FIGS. 7 and 9) is the distance the camera 12 and the vehicle 20 traveled during the time interval T₂. From the photographs it is determined that W is the distance between the respective tie plates. As the vehicle 20 continues to be advanced, the process is repeated and the relative positions of the tie plates and other components are established and saved by the control system 16. This information is used by the control system as described. As the time intervals T between the taking of the images is known, and in many cases fixed, the control system can use the distance moved by the camera 12 and the time interval T between images to determine the speed of the camera 12, and consequently the speed of the railcar or vehicle.

The position of the camera 12 relative to the frame 30 of the vehicle 20 is known. The position of the workhead(s) 22, which are fixed to the frame 30, is also known. Consequently, upon the transmission of the information gathered by the camera 12 and analyzed through the control system 16, the control system 16 will move the vehicle 20 into proper position relative to the respective component upon which maintenance is to be performed. Once in position, the control system 16 will control the operation of the workhead(s) 22 to perform the required maintenance.

In an alternate exemplary embodiment, the vehicle control system 16 may include a communication system 32 (shown schematically) that is structured to communicate with the communication system 82 of a satellite vehicle 70, discussed below. In the embodiment shown, the control system 16 is in electronic communication, typically by a hardwire and/or a wireless system, with the propulsion device 28, the workhead(s) 22, and the camera 12, as previously described. That is, the control system 16 sends data, including commands, to and/or receives data from the propulsion device 28, the workhead(s) 22, and the camera 12.

As shown in FIG. 3, the vehicle 20 may include a satellite or drone vehicle 70. While the satellite vehicle 70 shown in FIG. 3 is a vehicle which operates within the frame 30 of vehicle 20, the satellite vehicle 70 may be other type of vehicles, such as, but not limited to a vehicle similar to vehicle 20. The satellite vehicle 70 includes a propulsion device 78, a control system 66, and at least one workhead 72 structured to perform maintenance on the railroad track. The workheads 72 may include, but not be limited to, anchor squeezers, spike drivers, track stabilizers, crib booms, tie extractors, single and double brooms, and tampers. A plurality of rail wheels 74 are attached to the frame 80 of the satellite vehicle 70. The wheels 74 are structured to travel over the rails 26. The propulsion device 78 is structured to propel the satellite vehicle 70 over the rails 26.

The control system 66, which may include a computer and/or other similar components, may include a communication system 82 (shown schematically) that is structured to communicate with the communication system 32 of the vehicle 20 and a distance measurement link to accurately locate the satellite vehicle 70 relative to the vehicle 20. That is, the satellite control system 66 and vehicle control system 16 are structured to communicate with each other. The vehicle control system 16 is structured to provide component position data to the satellite control system 66. The satellite control system 66 is structured to provide data, generally relating to the condition of the satellite vehicle 70, e.g. satellite vehicle position data, movement data, configuration of the workheads, etc., to the vehicle control system 16. The satellite control system 66 is in electronic communication, typically by a hardwire and/or a wireless system, with the satellite vehicle propulsion device 78 and the workhead(s) 72. That is, the control system 66 sends data, including commands, to and/or receives data from the vehicle propulsion device 78 and the workhead(s) 72.

In addition to collecting and tracking distance data, movement data, and tie location data, the satellite vehicle control system 66 is structured to control the satellite propulsion device 78 and the actuation of the satellite workhead(s) 72. Preferably, this operation is generally automatic. That is, based on the tracking distance data, movement data, and component location data, the satellite control system 66 may engage the propulsion device 78 to move the satellite vehicle 70 into a position so that the workhead(s) 72 is disposed over a component. The satellite control system 66 may then actuate the satellite workhead(s) 72 to perform an appropriate cycle at the worksite tie. Alternatively, the vehicle control system 16 may be used to control the satellite vehicle 70.

In operation, the vehicle control system 16, through the use of the vision system 10 described above, will identify a location for a respective component which is need of maintenance. Referring to FIGS. 4 to 9, an example of the process of the vision system is shown. In this example, the component which is identified is a tie plate, but the basic process is similar for any component. The vision system 10 takes a first image, represented by 50, as shown in FIG. 4. As shown in FIG. 5, the image is analyzed by the pattern recognition software to determine that a respective tie plate is positioned in the field of view of the camera 12. Point 40 represents the center pixel of the image 50. The vehicle 20 advances and a second image is taken, represented by 52 in FIG. 6, after a defined time interval T₁. The image is analyzed, as represented in FIG. 7. Point 42 represents the center pixel of the image 52. The difference between X and Y (FIGS. 5 and 7) is the distance the camera 12 and the vehicle 20 traveled during the time interval T₁. The vehicle 20 continues to advance and a third image is taken, represented by 54 in FIG. 8, after a second defined time interval T₂. The image is analyzed, as represented in FIG. 9. Point 44 represents the center pixel of the image 54. The difference between Y and Z (FIGS. 7 and 9) is the distance the camera 12 and the vehicle 20 traveled during the time interval T₂. From the photographs it is determined that W is the distance between the respective tie plates. As the vehicle 20 continues to be advanced, the process is repeated and the relative positions of the tie plates and other components are established and saved by the control system 16. This information is used by the control system as described.

The position of the camera 12 relative to the frame 30 of the vehicle 20 is known. The position of the workhead(s) 22 (if any), which are fixed to the frame 30, is also known. The position of satellite vehicle 70 relative to the vehicle 20 is variable but known through the communication of the control system 16 and control system 66. The position of the workhead(s) 72 of the satellite device 70 is also variable and known through the communication of the control system 16 and control system 66. Consequently, upon the transmission of the information gathered by the camera 12 and analyzed through the control system 16 to the satellite control system 66, the satellite control system 66 will move the satellite vehicle 70 into proper position relative to the respective component upon which maintenance is to be performed. As the distance between the vehicle 20 and the satellite vehicle 70 is constantly changing (as the vehicle 20 is essentially a constant moving device and the satellite vehicle 70 is generally indexed from worksite to worksite), the satellite control system 66 must determine the distance between the satellite vehicle 70 and the vehicle 20 prior to advancing to the next worksite in order to insure that the satellite vehicle 70 and workhead(s) 72 are properly positioned. Once in position, the control system 66 will control the operation of the workhead(s) 72 to perform the required maintenance.

The communication between the control system 16 of the vehicle 20 and the control system 66 of the satellite vehicle 70 may be used to instruct the satellite vehicle 70 to skip components on which the vehicle 20 has previously completed the work and to skip components on which no maintenance is required.

In an alternate exemplary embodiment, the vision system 10 may be provided at the trailing end or back of the maintenance vehicle. In such case, the vision system 10 can be used as quality control device to measure the work done and ensure that all of the work is completed.

The use of the vision system 10 has many advantages. The vision system allows the vehicles and operation to be automated, thereby reducing or eliminating the need for human operators and thereby reducing the costs associated with the operation of the maintenance vehicles 20. The use of the vision system 10 also allows for more efficient and better quality work to be performed. As the vision system is located on the maintenance vehicle, the need for costly communication systems and position locating systems is eliminated. The vision system also can be used to: check that all ties plates and other components are present and properly positioned; check that all components are properly installed; check that all positional relationships of the components are correct; facilitate the marking of the track to indicate areas of needed correction; and provide a permanent record of the condition of the track.

It should be understood that whereas the above embodiments of the vision system have been described using components based on specific technologies, the present invention is not limited thereto, and may be implemented using components that are based on alternative technologies.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A railcar or a vehicle adapted to travel on a railroad track and perform maintenance on rail components of the railroad track, the railcar comprising:
a vision inspection system mountable on the railcar, the vision inspection system being adapted to facilitate identification and inspection of the rail components while traveling on the railroad track, the vision inspection system comprising:
a vision device adapted to provide an image of each rail component;
image recognition component which analyzes the images taken by the vision device to determine the type and condition of each rail component;
workheads mountable on the railcar, the workheads configured to perform maintenance on respective rail components;
a control system which communicates with the vision inspection system and the workheads, the control system compare images of taken by the vision system to determine distance between respective rail components;
whereby the control system causes the workheads to engage respective rail components based on the input received from the vision inspection system.

2. The railcar as recited in claim 1, wherein a light source is provided proximate the vision device to provide illumination to at least one rail of the railroad track to illuminate the rail components.

3. The railcar as recited in claim 1, wherein the control system includes a computing device adapted to compare images taken by the vision device to determine the speed of the railcar, whereby the control system will properly position the workheads in position relative to a respective rail component.

4. The railcar as recited in claim 1, wherein a timing device is provided to interact with the vision device, the timing device causing the vision device to take images at controlled intervals.

5. The railcar as recited in claim 1, wherein the vision device is a high-resolution camera.

6. The railcar as recited in claim 1, wherein the railcar includes a satellite vehicle which has a satellite control system which communicates with the control system, the satellite vehicle having the workheads mounted thereon.

7. A method for inspecting and servicing predetermined rail components of a railroad track while traveling on the railroad track, the method comprising the steps of:
providing a vision inspection system, a control system and at least one workhead on a rail vehicle;
using the vision inspection system to take images of a rail of the railroad track;
comparing the images of the rail to stored images of rail components to identify the components in the images and to determine if such components are in need of service;
communicating to a control system the location of the rail components in need of service;
positioning the at least one workhead in position relative to the rail components in need of service.

8. The method of claim 7, further including the step of capturing and storing said image of each predetermined rail component that is provided by the vision inspection system.

9. The method of claim 7, further including the step of illuminating at least one rail of the railroad track to illuminate the rail components.

10. The method of claim 7, further including the step of controlling the vision inspection system to take images at timed intervals.

11. The method of claim 7, further including the step of positioning the vision system at the leading end of the rail vehicle.

12. The method of claim 7, further including the step of positioning the vision system at the trailing end of the rail vehicle.

13. The method of claim 7, further including the steps of the vision system taking a first image; analyzing the first image to identify respective rail components; advancing the vision system to a second position; taking a second image; comparing the position of the respective rail components of the first image to the position of the respective rail components of the second image to determine the distance the vision system and the rail vehicle have moved.

14. The method of claim 13, further including the step of calculating the speed of the rail vehicle by using the distance that the rail vehicle has moved and the length of the time intervals between taking the images.

15. The method of claim 14, further including the step of the control system using the speed of the rail vehicle and the relative position of the respective components to position the at least one workhead in position relative to the rail components in need of service, whereby the at least one workhead is positioned to perform maintenance on the rail components in need of service.

16. A method for identifying rail components of a railroad track and determining the relative distance between the rail components while traveling on the railroad track, comprising the steps of:
taking a first image with a vision inspection system of a rail of a railroad track;
analyzing the first image to identify respective rail components of the rail;
advancing the vision system to a second position;
taking a second image;
comparing the position of the respective rail components of the first image to the position of the respective rail components of the second image to determine the distance the vision system and the rail vehicle have moved.

17. The method of claim 16, further including the step of controlling the vision inspection system to take images at timed intervals.

18. The method of claim 17, further including the step of calculating the speed of the rail vehicle by using the distance that the rail vehicle has moved and the length of the time intervals between taking the images.

19. The method of claim 18, further including the steps of:
comparing the images of the rail to stored images of rail components to identify the components in the images and to determine if such components are in need of service;
communicating to a control system the location of the rail components in need of service.

20. The method of claim 19, further including the step of positioning at least one workhead in position relative to the rail components in need of service.

21. The method of claim 16, further including the step of controlling the vision inspection system to take images at random intervals.

22. A vision inspection system for use with a railcar or a vehicle adapted to travel on a railroad track and perform maintenance on rail components of the railroad track, the vision inspection system comprising:
a vision device adapted to provide an image of each rail component;
image recognition component which analyzes the images taken by the vision device to determine the type and condition of each rail component as the vehicle is traveling on the railroad track,
a control system which communicates with the vision device and the image recognition component;
whereby the control system causes workheads of the vehicle to engage respective rail components based on the input received from the vision inspection system.
